(19) United States
(12) Patent Application Publication
(10) Pub. No.: US 2008/0270010 A1
(43) Pub. Date: Oct. 30, 2008

(54) Method and apparatus for detecting engine racing

(75) Inventors: Satoshi Harumoto, Hyogo (JP); Yuusaku Matsuda, Hyogo (JP); Kouei Kiyo, Hyogo (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/081,473

(22) Filed: Apr. 16, 2008

(30) Foreign Application Priority Data
Apr. 26, 2007 (JP) 2007-117612

(51) Int. Cl. B60W 10/06

(52) U.S. Cl. 701/110

(57) ABSTRACT

An engine racing detecting apparatus detects engine racing of an engine of a vehicle. The engine racing detecting apparatus includes a rotation-speed acquiring unit, a clutch-state acquiring unit, and an engine-racing determining unit. The rotation-speed acquiring unit acquires a rotation speed of the engine. The clutch-state acquiring unit acquires clutch state indicative of whether a clutch of the engine is ON or OFF. The engine-racing determining unit determines whether the engine races based on the rotation speed when the clutch state indicates that the clutch is OFF.

### BACKGROUND OF THE INVENTION

1. Field of the Invention

The present invention relates to a method and apparatus for detecting engine racing.

2. Description of the Related Art

It is desirable to avoid engine racing when driving a vehicle for improvement in fuel consumption efficiency and reduction of noises. The engine racing means a state that the driver unnecessarily increases the rotation speed of the engine while the clutch of the gearshift mechanism is in the OFF state, i.e., while the engine is not connected to any gears. Avoiding engine racing is also important from the view point of reduction in greenhouse gas emission.

A technology to evaluate the gearshift operation performed by a driver has been proposed. For example, Japanese Patent Application Laid-open No. 2006-299921 discloses a conventional technology for evaluating a shift-up operation. Specifically, a shift-up operation is detected from the operations performed by a driver based on a recorded vehicle speed, then the shift-up operation is evaluated based on a frequency of an engine rotation speed exceeding a predetermined reference value in a process of the shift-up operation.

Japanese Patent Application Laid-open No. 2002-362185 discloses a conventional technology of determining engine racing based on the rotation speed of the engine and a degree of operation of an accelerator while a vehicle speed is zero.

In the conventional technology disclosed in Japanese Patent Application Laid-open No. 2002-362185, it is possible to detect the engine racing while a vehicle speed is zero. However, it is difficult to detect the engine racing while a vehicle is running.

While a vehicle is running, a clutch is turned to the OFF state to shift gears (shift gears up or down) in a gearshift mechanism, and a rotation speed of an engine is increased in accordance with a selected gear. Such an increase in the rotation speed can be mistakenly detected as the engine racing. Therefore, it is required to distinguish between the gear shifting and the engine racing.

### SUMMARY OF THE INVENTION

It is an object of the present invention to at least partially solve the problems in the conventional technology. An engine racing detecting apparatus comprising:

According to an aspect of the present invention, an engine racing detecting apparatus includes a rotation-speed acquiring unit that acquires a rotation speed of an engine; a clutch-state acquiring unit that acquires clutch state indicative of whether a clutch of the engine is ON or OFF; and an engine-racing determining unit that determines whether the engine races based on the rotation speed when the clutch state indicates that the clutch is OFF.

According to another aspect of the present invention, a method of detecting engine racing includes acquiring a rotation speed of an engine; acquiring clutch state indicative of whether a clutch of the engine is ON or OFF; and determining whether the engine races based on the rotation speed when the clutch state indicates that the clutch is OFF.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an engine-racing determining apparatus according to an embodiment of the present invention;

FIG. 2 is a graph for explaining a relation between shift-up operation and a rotation speed of an engine according to the embodiment;

FIG. 3 is a graph for explaining a method of determining engine racing based on fluctuation of the rotation speed according to the embodiment; and

FIG. 4 is a flowchart of operation performed by the engine-racing determining apparatus.

### DETAILED DESCRIPTION OF THE PREFERRED EMBODIMENTS

Exemplary embodiments of the present invention are explained in detail below with reference to the accompanying drawings.

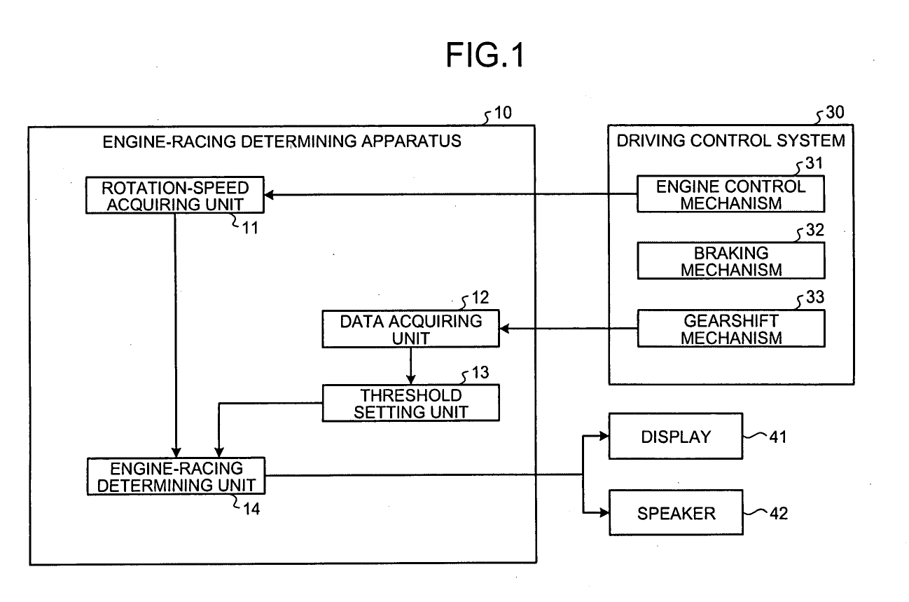

FIG. 1 is a block diagram of an engine-racing determining apparatus 10 according to an embodiment of the present invention. The engine-racing determining apparatus 10 is connected to a driving control system 30, a display 41, and a speaker 42.

The driving control system 30 controls driving of a vehicle (not shown) in response to driving operation by a driver. The driving control system 30 includes an engine control mechanism 31, a braking mechanism 32, and a gearshift mechanism 33. The engine control mechanism 31 controls rotation of an engine (not shown) in response to operation of an accelerator pedal (not shown) by the driver. The braking mechanism 32 applies brake to the vehicle in response to operation of a brake pedal (not shown) by the driver. The gearshift mechanism 33 shifts gears (not shown) in response to operation of a clutch pedal (not shown) and a shift lever (not shown) by the driver.

The display 41 and the speaker 42 provide the driver with information by displaying the information and outputting the information with voice. The display 41 and the speaker 42 can be commonly used in other in-vehicle devices, such as a navigation system and a car audio system.

The engine-racing determining apparatus 10 determines whether the driver causes the engine to race by using data acquired from the driving control system 30. The engine-racing determining apparatus 10 includes a rotation-speed acquiring unit 11, a data acquiring unit 12, a threshold setting unit 13, and an engine-racing determining unit 14.

The rotation-speed acquiring unit 11 acquires a rotation speed of the engine from the engine control mechanism 31. The data acquiring unit 12 acquires data about a state of a clutch (not shown) and a currently selected gear from the gearshift mechanism 33. The threshold setting unit 13 sets a threshold of the rotation speed based on the data about the currently selected gear acquired by the data acquiring unit 12. The threshold of the rotation speed is used for determining whether the engine racing has occurred.

The engine-racing determining unit 14 determines whether the engine racing has occurred based on the rotation speed of the engine acquired by the rotation-speed acquiring unit 11, the state of the clutch acquired by the data acquiring unit 12, and the threshold of the rotation speed set by the threshold setting unit 13.

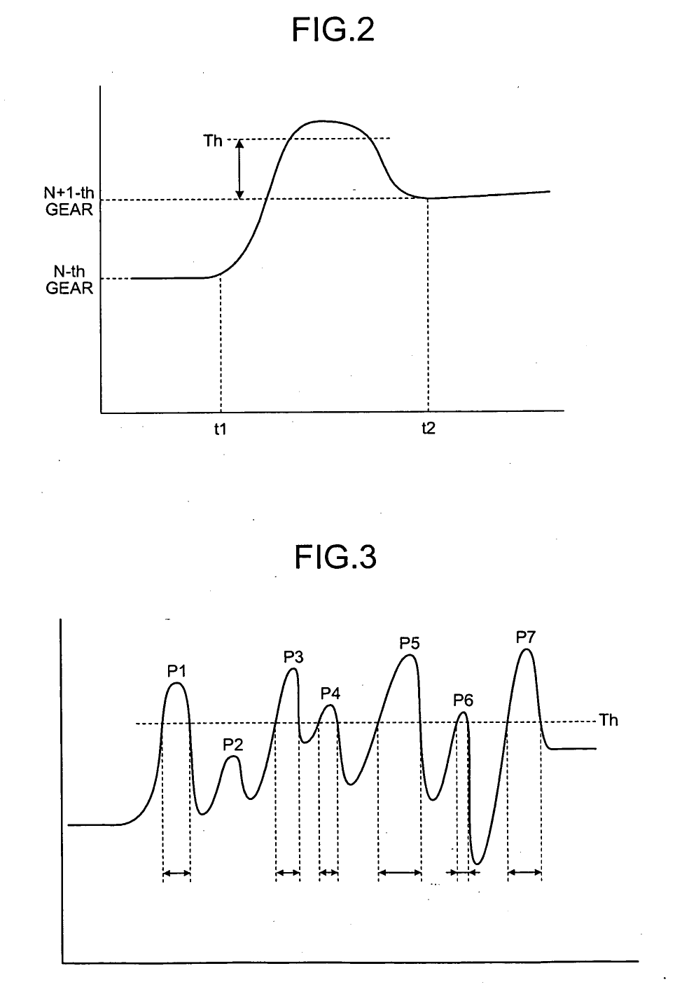

FIG. 2 is a graph for explaining a relation between shift-up operation and a rotation speed of the engine. When the gear is shifted up from the N-th gear to the N+1-th gear, the rotation speed increases from a time t1 at which the clutch is turned to the OFF state. Afterward, when the clutch is turned to the ON state at a time t2, the rotation speed is a value corresponding to the N+1-th gear.

A rotation speed of the engine is determined for each of the gears. The engine-racing determining apparatus 10 adds a predetermined value to the rotation speed corresponding to the N+1-th gear, thereby setting a threshold of the rotation speed. The engine-racing determining apparatus 10 then compares the rotation speed during the clutch being OFF with the threshold, thereby determining whether the engine racing has occurred.

If it is determined that an engine racing has occurred when the engine rotation speed exceeds the threshold only once while the clutch is OFF, the determination can be useless. Specifically, it is determined that engine racing has occurred even when the engine rotation speed increases without driver's intention due to a mismatch of an clutch ON-OFF operation and an accelerator operation.

To solve the above-described problem, the engine-racing determining unit 14 determines that the engine racing has occurred when the following conditions are satisfied: (1) when an average of rotation speed of the engine during a period the clutch is OFF exceeds a threshold of the rotation speed; (2) when the number of times when the rotation speed exceeds the threshold of the rotation speed during a period the clutch is OFF exceeds the predetermined number of times; and (3) when a total period when the rotation speed exceeds the threshold of the rotation speed during a period the clutch is OFF exceeds a threshold of the period.

FIG. 3 is a graph for explaining a method of determining the engine racing based on fluctuation of the rotation speed of the engine. While the clutch is in the OFF state, the rotation speed fluctuates with seven peaks P1 to P7. The rotation speed exceeds the threshold at the peaks P1, P3 to P7, although the rotation speed does not exceed the threshold at the peak P2.

In a case the engine racing of the engine is determined based on the number of times that the rotation speed exceeds the threshold, it is determined whether the number of the peaks P1, P3 to P7 excluding the peak P2 is larger than the predetermined number.

Furthermore, in a case the engine racing is determined based on a total period during which the rotation speed exceeds the threshold, the total period is calculated by adding the periods during which the rotation speed exceeds the threshold, i.e., the periods of the peaks P1, P3 to P7. When the total period is longer than the predetermined threshold of the period, it is determined that the driver caused the engine to race.

The driver is notified of determination on the engine racing made by the engine-racing determining unit 14 via the display 41 or the speaker 42. In this manner, it is possible to notify the driver of occurrence of the engine racing, thereby urging the driver to avoid the engine racing during a subsequent driving operation. Thus, it is possible to improve fuel consumption efficiency, and to reduce noises.

Although it is explained above that the driver is notified of the determination made by the engine-racing determining unit 14, determination on a driving speed can be used for a general purpose by using any method.

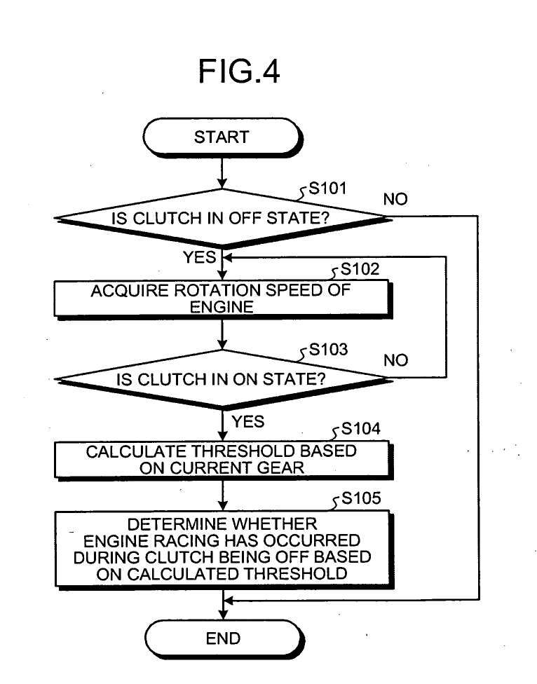

FIG. 4 is a flowchart of operation performed by the engine-racing determining apparatus 10. The flowchart indicates a main process that is repeatedly performed by the engine-racing determining apparatus 10.

The engine-racing determining apparatus 10 determines whether the clutch is in the OFF state based on data about a state of the clutch acquired by the data acquiring unit 12 (Step S101). If the clutch is not in the OFF state (No at Step S101), the process ends.

If the clutch is in the OFF state (Yes at Step S101), the rotation-speed acquiring unit 11 acquires a rotation speed of the engine (Step S102). The rotation-speed acquiring unit 11 repeatedly acquires the rotation speed until the clutch is turned to the ON state again (Yes at Step S103).

When the clutch is in the ON state (Yes at Step S103), a threshold of the rotation speed is calculated based on the currently selected gear (Step S104). The engine-racing determining unit 14 then determines whether the engine racing has occurred during the clutch being OFF based on the calculated threshold (Step S105), and the process ends.

In a case the driver turns the clutch OFF to intentionally race the engine, a period during which the clutch is in the OFF state can be longer than that in a case the user turns the clutch OFF to shift the gears. Therefore, the engine-racing determining unit 14 can be configured as described below. The engine-racing determining unit 14 measures a period from an operation of turning the clutch OFF to an operation of turning the clutch ON. When the measured period, i.e., the period during which the clutch is in the OFF state, is longer than the predetermined period, the engine-racing determining unit 14 determines whether the engine racing has occurred.

It can be configured such that the threshold of the rotation speed and the threshold of the period are changed depending on a period during which the clutch is in the OFF state.

As described above, the engine-racing determining apparatus 10 monitors the rotation speed while the clutch is in the OFF state, and evaluates the fluctuation of the rotation speed. In this manner, the engine-racing determining apparatus 10 distinguishes between the gear shifting and the engine racing even when the vehicle is running. Thus, the engine-racing determining apparatus 10 can detect the engine racing caused by the driver with a high accuracy.

The engine-racing determining apparatus 10 can determine whether the engine racing has occurred while the vehicle speed is zero.

The configuration and the operation of the embodiment are described as an example, and therefore any modification can be made in the embodiment. For example, the fluctuation of the rotation speed can be evaluated by using any method.

According to an aspect of the present invention, it is possible to distinguish between the gear shifting and the engine racing even when the vehicle is running, and therefore the engine racing can be detected with a high accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An engine racing detecting apparatus comprising:
a rotation-speed acquiring unit that acquires a rotation speed of an engine;
a clutch-state acquiring unit that acquires clutch state indicative of whether a clutch of the engine is ON or OFF; and
an engine-racing determining unit that determines whether the engine races based on the rotation speed when the clutch state indicates that the clutch is OFF.

2. The engine racing detecting apparatus according to claim 1, wherein
when an average of the rotation speed during a period the clutch state indicates that the clutch is OFF exceeds a first threshold, or when number of times when the rotation speed exceeds the first threshold during a period the clutch state indicates that the clutch is OFF exceeds a predetermined number of times, or when a total period when the rotation speed exceeds the first threshold during a period the clutch state indicates that the clutch is OFF exceeds a second threshold, the engine-racing determining unit determines that the engine races.

3. The engine racing detecting apparatus according to claim 2, further comprising a threshold setting unit that sets the first threshold depending on a gear that is selected when the clutch is ON.

4. The engine racing detecting apparatus according to claim 1, wherein the engine-racing determining unit determines whether the engine races when a period that the clutch being OFF is longer than a predetermined period.

5. A method of detecting engine racing, comprising:
acquiring a rotation speed of an engine;
acquiring clutch state indicative of whether a clutch of the engine is ON or OFF; and
determining whether the engine races based on the rotation speed when the clutch state indicates that the clutch is OFF.
